(19) United States
(12) Patent Application Publication
(10) Pub. No.: US 2008/0220662 A1
(43) Pub. Date: Sep. 11, 2008

(54) Electric Contact for High-Temperature Fuel Cells and Methods for The Production of Said Contact

(75) Inventors: Nikolai Trofimenko, Dresden (DE); Mihail Kuznecov, Dresden (DE)

Correspondence Address: JACOBSON HOLMAN PLLC, 400 SEVENTH STREET N.W., SUITE 600, WASHINGTON, DC, 20004, US

(73) Assignee: Fraunhofer-Gesellschaft Zur Foerderung Der Angewandten Forschung E.V., München (DE)

(21) Appl. No.: 10/571,092

(22) PCT Filed: Aug. 30, 2004
(86) PCT No.: PCT/DE2004/001964

§ 371 Date: Jan. 28, 2008

(30) Foreign Application Priority Data
Sep. 8, 2003 (DE) 103 42 161.0

(51) Int. Cl. H01R 13/40; B23K 31/02; H01R 43/02

(52) U.S. Cl. 439/733.1; 228/194; 29/877

(57) ABSTRACT

An electric contact for high-temperature fuel cells and to methods for the production of said contacts. The aim of the invention is to enable long-term use at high operating temperatures of up to 950° C., offering high electrical conductivity and being able to be produced at low cost. The inventive electric contact is produced from a composite consisting of a metal component and a ceramic component. The metal component is, preferably, formed with at least one metal oxide.

The invention relates to an electrical contact for high-temperature fuel cells and also a method for producing such a contact.

The invention relates to an electrical contact for high-temperature fuel cells and also a method directed towards the production of such an electrical contact. The electrical contacts according to the invention can be used preferably on the anode side of high-temperature fuel cells, at which the respective fuel, such as e.g. hydrogen and suitable low molecular hydrocarbon compounds, such as natural gas or methane, is supplied for the actual process. The reducing effect thereof can thereby be exploited specifically.

High-temperature fuel cells are frequently combined electrically to form more complex units, i.e. a plurality of such individual fuel cells, and are thereby connected to each other in series and/or in parallel in order to achieve an increased electrical output power. Fuel cell stacks are thereby formed.

In these cases, the individual respective high-temperature fuel cells are provided with interconnectors, normally so-called bipolar plates.

It is necessary for this purpose that the electrodes of the respective fuel cell, i.e. a cathode and also an anode, are connected in an electrically conductive manner to the respective interconnector assigned to them.

For the electrically conductive connection of an anode to an interconnector, it is known for example from DE 196 49 457 C1 to use a flexibly deformable network made of nickel between interconnector and anode, which network can be contacted with the interconnector and the anode.

During operation of a fuel cell configured in this way, an oxide layer which essentially comprises chromium oxide is formed very rapidly. This chromium oxide layer is formed on the surface of the interconnector which points into the interior of the fuel cell, also in regions in which the nickel network is in touching contact with the interconnector.

The electrical resistances and transition resistances are correspondingly increased, which leads to a considerable reduction in electrical conductivity which in turn results in a reduction in the degree of efficiency of such a high-temperature fuel cell.

However, such an oxide layer also impairs connection points, obtained by welding, of a nickel network to the interconnector, a downward travel of the welding points with the formed chromium oxide being able to be noted.

In DE 198 36-352 A1 it is proposed in order to avoid the formation and downward travel with such oxide layers to form a thin protective layer made of pure nickel. Protective layers made of nickel with other elements are also known from DE 199 13 873 A1.

Even with such protective layers, it is not possible to eliminate all the disadvantages present in the state of the art.

In addition, also mechanical influences, such as vibrations, pressure changes and tensile stresses cannot always be compensated for with the protective layers or a sufficiently large resistance to such influences cannot be achieved, and correspondingly the electrically conductive connection is also impaired again in an undesired form.

Furthermore, problems occur due to the considerable temperature differences and the redox cycle occurring during operation of fuel cells.

It is therefore the object of the invention to provide such an improved electrical contact for high-temperature fuel cells which ensures an increased electrical conductivity on a long-term basis at increased operating temperatures up to 950° C. and thereby can be produced at the same time in a simple and cost-effective manner.

According to the invention, this object is achieved with an electrical contact for high-temperature fuel cells which has the features of claim 1. A production method for such electrical contacts is defined by patent claim 14.

Advantageous embodiments and developments of the invention can be achieved with the features described in the subordinate claims.

The electrical contact according to the invention is thereby configured in the form of a composite which comprises a metallic component and a ceramic component.

However, it can also be disposed and configured between elements of fuel cells which are to be connected to each other in an electrically conductive manner.

The metallic component of the composite is formed at least from one metal oxide, this metal oxide also being able to be unchanged, i.e. contained in the contact as a non-reduced chemical compound.

The possibility also exists however, that pure metal or alloys formed by reduction of metal oxides are contained in the contact. The ceramic component of the composite for the contact should advantageously be conductive for oxygen ions.

As already indicated, the metallic component of the composite can be formed at least temporarily from NiO, CuO and/or MgO. In this case, the nickel or else the copper represent the correspondingly reduced metal oxides and the magnesium oxide contained if necessary in the composite remains contained as such also in the finished electrical contact.

Zirconium oxide and cerium oxide have proved to be particularly suitable for the ceramic component. The ceramic components of the composite can thereby have been formed solely from zirconium oxide, solely from cerium oxide but also from both oxides together. Advantageously, stabilised zirconium oxide (ZrO₃)_{0.92}(Y₂O₃)_{0.08}, if necessary however also partially stabilised zirconium oxide (ZrO₂)_{0.97}(Y₂O₃)_{0.03}, should be used.

In the case of cerium oxide, this can advantageously be doped with other elements (e.g. Ca, Sr, Gd, Sc).

In the composite forming the electrical contact, the respective metallic component should be contained with 80 to 100% by mass and the ceramic component with 0 to 20% by mass.

In addition, it is desirable and advantageous if the metallic component, at least parts of this component, is contained in a highly dispersed form.

This can be achieved via fine grinding of corresponding powders which can be used for the formation of the electrical contact.

If for example oxides are used as initial powder for the metallic component, then a particle size, which is reduced relative to the particle size of the initial powders, of a pure metal obtained by reduction or of a corresponding metal alloy can be achieved within the contact.

The contact formed on or between the electrically conductive elements to be contacted should have a thickness of 2 to 500 μm in order to be able to ensure the desired long-term protection with simultaneous sufficiently high electrical conductivity.

The electrical contact can be formed at least on one surface of a metallic network which is disposed between an anode and the interconnector assigned thereto in a high-temperature fuel cell.

Such a metallic network, as was able to be formed in the state of the art also from nickel, should have been provided at least on the surface which is in contact with the anode with a contact according to the invention.

A contact according to the invention can however also have been formed in a planar manner on the corresponding surface of the anode and/or on the surface of the interconnector pointing into the interior of the fuel cell.

For the production of an electrical contact according to the invention for high-temperature fuel cells, the process can be such that, on elements to be connected to each other electrically conductively but also between such electrically conductive elements, a mixture which is formed from a metallic and a ceramic component is applied.

Subsequent to this application, a heat treatment and a supply of a reduction agent are effected, the supply of the reduction agent being able to be effected with a time lag after reaching a specific prescribable minimum temperature.

As a result, an at least partial reduction of a metal oxide, which is a component of the metallic component in the contact, into the corresponding pure metal or a metal alloy and also hardening of the contact is achieved.

At the same time, binder components contained possibly in the initial mixture can be expelled.

Advantageously, the heat treatment and the reduction can be implemented in situ within the high-temperature fuel cell, the respective fuel being able to act as reduction agent.

As a result of the heat treatment, an adhesive diffusion bond can be formed on the interfaces of the electrically conductive elements to be contacted with each other.

As already indicated, both the metallic component and the ceramic component can be used in powder form, it being favourable to mix the latter with each other together with a binder and if necessary a suitable solvent, such as e.g. water and an organic solvent, so that a pasty consistency can be set.

In this pasty form, the mixture can be applied.

An application can thereby be effected by screen printing technology which is known per se or by rolling on.

A mixture having a correspondingly suitable consistency can however also be applied in the wet powder spraying process.

With the solution according to the invention, a long-term and effective protection of the nickel from oxidation can be achieved even at the increased temperatures prevailing within the fuel cell during operation thereof and with the effect of the respective fuel, and an increase in electrical resistance can be avoided.

Furthermore, the catalytic activity of a high-temperature fuel cell can be improved by a correspondingly achievable enlargement of the active anode surface area.

The electrical contact according to the invention is however chemically and thermally resistant even during the frequently occurring redox cycles, which ensures a long-term sufficiently high electrical conductivity in addition.

As already indicated, an increased adhesive strength of the contact can be achieved by the achievable diffusion bond.

Subsequently, the invention is intended to be explained in more detail by way of example.

There are thereby shown:

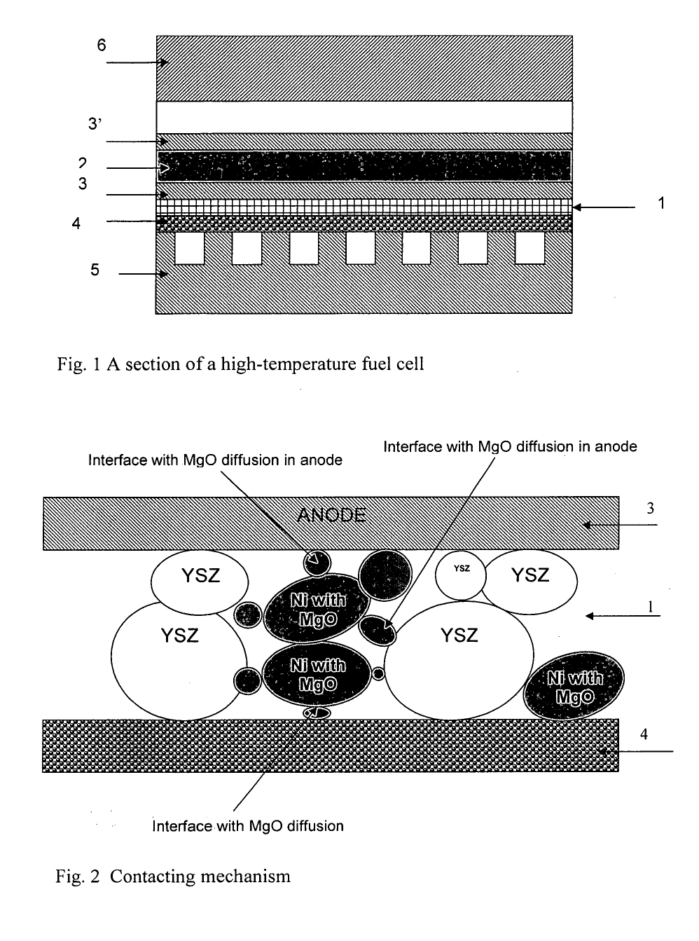

FIG. 1 in schematic form, a sectional representation through a high-temperature fuel cell with an electrical contact formed between a metallic network and the anode of the fuel cell and

FIG. 2 in schematic form and enlargement, the electrical contact formed between the metallic network and anode in an example.

In FIG. 1, a section through a high-temperature fuel cell is represented in schematic form.

In this example, a bipolar plate is disposed on the cathode side as an interconnector 6.

Abutting thereon, an electrode unit with a cathode 3′, a solid electrolyte 2 and the anode 3 is present.

On the side of the fuel cell situated opposite the interconnector 6, a further interconnector 5 is disposed in the case of which, in schematic form, channels have been formed for the supply of a suitable fuel for operation of the fuel cell by means of corresponding structuring.

On the surface of the interconnector 5 pointing into the interior of the high-temperature fuel cell, said interconnector being able to be configured likewise as a bipolar plate, a metallic network 4 made of nickel was placed. The connection of the metallic network 4 to the interconnector 5 can have been produced at points by welding.

The electrical contact 1 was formed on the surface of the metallic network 4 pointing in the direction of the anode 3.

For this purpose, a composite mixture of nickel oxide and magnesium oxide was applied as metallic component with zirconium oxide stabilised by yttrium oxide, as has been explained already in the general part of the description.

In FIG. 1, a gas channel is shown furthermore between cathode 3′ and interconnector 6 for the supply of the oxidant necessary for operation of the fuel cell (oxygen or air).

The surface of the interconnector 5 pointing in the direction of the interior of the high-temperature fuel cell was provided in advance with a nickel protective layer.

After application of the mixture containing the already mentioned metallic component and the ceramic component onto the surface of the metallic network 4, here with a layer thickness of 300 μm, and subsequent assembly of the fuel cell, the latter was normally put into operation so that, with simultaneous heating, i.e. a quasi heat treatment, the nickel oxide initial powder was reduced entirely to metallic nickel. At the same time, with the magnesium oxide, an adhesive diffusion bond between anode 3, metallic network 4 and the electrical contact 1 was formed and also with the stabilised zirconium oxide forming the ceramic component at the respective interfaces.

Hence with sufficiently high electrical conductivity between metallic network 4 and anode 3 and correspondingly also to the interconnector 5, a sufficiently high electrical conductivity can be achieved with simultaneously secure protection from undesired oxide layer formation reducing in particular the electrical conductivity within this critical region.

1: Electrical contact for high-temperature fuel cells which is formed as a composite comprising a metallic component and a ceramic component.

2: Contact according to claim 1, characterised in that the metallic component is formed with at least one metal oxide.

3: Contact according to claim 1, characterised in that the ceramic component is conductive for oxygen ions.

4: Contact according to claim 1, characterised in that nickel, copper or an alloy of these elements is contained in the metallic component.

5: Contact according to claim 1, characterised in that NiO, CuO and/or MgO is/are contained in the metallic component.

6: Contact according to claim 1, characterised in that ZrO₂ and/or CeO₂ is/are contained in the ceramic component.

7: Contact according to claim 1, characterised in that the metallic component is contained with 80 to 100% by mass and the ceramic component with 0 to 20% by mass.

8: Contact according to claim 1, characterised in that stabilised ZrO₂ is contained.

9: Contact according to claim 1, characterised in that doped CeO₂ is contained.

10: Contact according to claim 1, characterised in that the metallic component is contained in a highly dispersed form.

11: Contact according to claim 1, characterised in that it has a thickness of 2 to 500 μm.

12: Contact according to claim 1, characterised in that the contact (1) is formed on the surface of a metallic network (4) which is disposed between an anode and an interconnector (5) of a high-temperature fuel cell.

13: Contact according to claim 1, characterised in that the contact (1) is formed in a planar manner on the surface of the anode (3) and/or of an interconnector (5) of a high-temperature fuel cell.

14: Method for producing an electrical contact for high-temperature fuel cells in which a mixture containing a metallic and a ceramic component is applied on/between electrically conductive elements,
subsequently a heat treatment is implemented with supply of a reduction agent with simultaneous hardening of the contact (1) and
as a result an at least partial reduction of a metal oxide into a pure metal or a metal alloy is achieved.

15: Method according to claim 14,
characterised in that the heat treatment and reduction are implemented in situ within the high-temperature fuel cell.

16: Method according to claim 14,
characterised in that, during the heat treatment, an adhesive diffusion bond is formed at the interfaces of the electrically conductive elements to be contacted with each other.

17: Method according to one claim 14,
characterised in that a mixture comprising a pulverulent metallic component and a ceramic component is applied with a binder.

18: Method according to claim 14,
characterised in that the mixture is applied in pasty form.

19: Method according to claim 14,
characterised in that the mixture is applied by a wet powder spraying process, by screen printing or by rolling on.
